(19) United States
(12) Patent Application Publication
(10) Pub. No.: US 2009/0315818 A1
(43) Pub. Date: Dec. 24, 2009

(54) Method and Related Apparatus for Driving a Flat Panel Display

(76) Inventor: Ju-Lin Huang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/198,871

(22) Filed: Aug. 26, 2008

(30) Foreign Application Priority Data
Jun. 24, 2008 (TW) 097123491

(51) Int. Cl. G09G 3/36

(52) U.S. Cl. 345/89

(57) ABSTRACT

A method for driving a flat panel display includes receiving image data corresponding to a picture with a gray level between a first gray level and a second gray level, generating a plurality of frame signals corresponding to a plurality of pixels in the flat panel display based on the image data of the picture, dividing each of the plurality of frame signals into a plurality of sub-frame signals, and adjusting levels of the plurality of sub-frame signals of each frame signal based on the first gray level and the second gray level to make a gray level shown by each pixel corresponding to each frame signal to be equal to the gray level of the picture.

### BACKGROUND OF THE INVENTION

1. Field of the Invention

The present invention relates to a method and related device for driving a flat panel display, and more particularly, to a method and related device for avoiding screen flickers owing to under speed of display frame rate of the flat panel display.

2. Description of the Prior Art

Liquid crystal device (LCD) has features like slim appearance, low energy consumption and no radiation hazards, and has been widely used as a display device of information technology products like computer system, mobile phone and personal digital assistant (PDA). The working principle of LCD is to apply physical properties of liquid crystal which has multiple alignment states with various degrees of polarizing and refractive effects such that the transmittance of light can be controlled. Furthermore, through the use of color filter, multiple gray levels of red, blue and green light can be displayed.

Please refer to FIG. 1. FIG. 1 is a schematic diagram of a thin film transistor (TFT) LCD 10 according to the prior art. The LCD 10 comprises an LCD panel 100, a timing control circuit 102, a data line signal output circuit 104, a scan line signal output circuit 106, and a common voltage generator 108. The LCD panel 100 comprises two substrates and liquid crystal material is filled in the space between the substrates. A substrate has a plurality of data lines 110, a plurality of scan lines (also named gate lines) 112 perpendicular to the data lines 110, and a plurality of TFTs built on it. Another substrate has a common electrode used to supply a common voltage Vcom via the voltage generator 108. For easy explanation, FIG. 1 shows only four TFTs 114. In a real TFT LCD device, the intersection of every data line 110 and scan line 112 has a TFT 114 connected on it, and therefore, the TFTs are distributed as a matrix on the LCD panel 100. Every data line 110 corresponds to a column, and every scan line 112 corresponds to a row, and every TFT corresponds to a pixel. Besides, the electrical properties of the two substrates comprised in the LCD panel can be considered as an equivalent capacitor 116.

Inside the LCD 10, the timing control circuit 102 can generate control signals onto the data line signal output circuit 104 and the scan line signal output circuit 106. The data line signal output circuit 104 and the scan line signal output circuit 106 can generate input signals to the data lines 110 and the scan lines 112 to control the conduction of the TFT 114 and the voltage difference between the two ends of the equivalent capacitor 116, and change further the alignments of the liquid crystal molecules and the corresponding light transmittance, so as to display a display data 122 on the panel. For example, the scan line signal output circuit 106 inputs a pulse signal onto the scan line 112 to conduct the TFT 114, and the data line signal output circuit 104 inputs a signal to the data line 110 such that the signal can input to the equivalent capacitor 116 via the TFT 114, so as to control the state of the gray level of the corresponding pixel. On the other hand, via controlling the levels of the signals output from the data line signal output circuit 104 to the data line 110, different gray levels can be generated.

To detail more about gray level display, for increasing gray levels without extra chip area or cost, the prior art adopts a differential difference amplifier (DDA) of dual input pairs or frame rate control (FRC) to realize the solution. Using the DDA can decrease the number of gamma voltage wirings and digital to analog converters by half. The decreased gamma reference voltage can be supplemented by interpolation of the DDA, but the shortage is that the chip area is increased by adding a set of amplifiers. The FRC method can increase the number of gray levels without increasing the chip area or the cost of the driving circuit. Please read the explanations stated as follows:

The FRC method is to use the visual staying phenomenon of human eyes to successive frames of images and to generate mid-level brightness by “flickering” the picture. A gray level is determined by controlling the number of turn-on times of the pixel. For a black and white display, assuming the frame rate of the display is X, if a pixel is supposed to display with full brightness, then the pixel is being turned on for X times. The working principle of the FRC is to control the turn-on times of the pixel such that the gray level of the pixel is determined by the proportion of the turn-on times relative to X. In the same time, new gray levels are generated by means of interpolation. For example, please refer to FIG. 2A to 2C. FIG. 2A to 2C illustrate schematic diagrams of output waveforms of picture frame signals corresponding to different channels and different frames, to illustrate how to generate an (N+1) gray level, a (2N+1)/2 gray level and an N gray level by the FRC method. Inside the diagrams, F1, F2 and F3 represent three successive frames, and CH1, CH2, and CH3 represent three neighboring channels. Besides, the dot inversion driving method is used as an example in FIG. 2A to FIG. 2C, and the polarity of the driving voltages Va and Vb of every pixel changes every single frame. As can be known in FIG. 2B, regarding CH1, the driving voltages from the frames F1 to F3 are Va, (−Vb), Va in sequence; regarding CH2, the driving voltages from the frames F1 to F3 are (−Vb), Va, (−Vb) in sequence; regarding CH3, the driving voltages from the frames F1 to F3 are Va, (−Vb), Va in sequence. In other words, to generate (2N+1)/2 gray level, the prior art uses both temporal compensation (by different frames) and spatial compensation (by different channels) via interpolation to generate the required gray levels. Therefore, under the condition of no extra chip area for driving circuit or cost, the FRC driving method can generate more gray levels by interpolation. Under this condition, the FRC driving method merely changes the number of turn-on times without changing the driving circuit, and therefore saves the production cost. However, in the process of applying the FRC driving method, the most critical issue is the frequency of the frame rate must be high enough to cover the visual staying phenomenon—the common range of the display frame rate is 42 Hz˜140 Hz—or the unfavorable flicker phenomena will be observed.

Simply speaking, the FRC driving method achieves the goal of increasing gray levels without increasing the chip area of the driving circuit or cost, but the display frame rate is required to be higher than the frequencies corresponding to the visual staying phenomenon to prevent the flicker phenomena from decreasing the picture quality.

### SUMMARY OF THE INVENTION

It is therefore an objective of the present invention to provide a method and related device for driving a flat panel display.

The present invention discloses a method for driving a flat panel display, which comprises receiving image data corresponding to a picture with a gray level between a first gray level and a second gray level, generating a plurality of frame signals corresponding to a plurality of pixels in the flat panel display, dividing each of the plurality of frame signals into a plurality of sub-frame signals, and adjusting levels of the plurality of sub-frame signals of each frame signal to make a gray level shown by each pixel corresponding to each frame signal to be equal to the gray level of the picture.

The present invention also discloses a driving device used in a flat panel display, which comprises a reception unit for receiving image data corresponding to a picture with a gray level between a first gray level and a second gray level; a signal generator coupled to the reception unit, for generating the plurality of frame signals corresponding to the plurality of pixels in the flat panel display based on the image data of the picture; a division unit coupled to the signal generator, for dividing each of the plurality of frame signals into the plurality of sub-frame signals; and an adjustment unit coupled to the division unit and the reception unit, for adjusting levels of the plurality of sub-frame signals of each frame signal based on the first gray level and the second gray level to make the gray level shown by each pixel corresponding to each frame signal to be equal to the gray level of the picture.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a thin film transistor LCD according to the prior art.

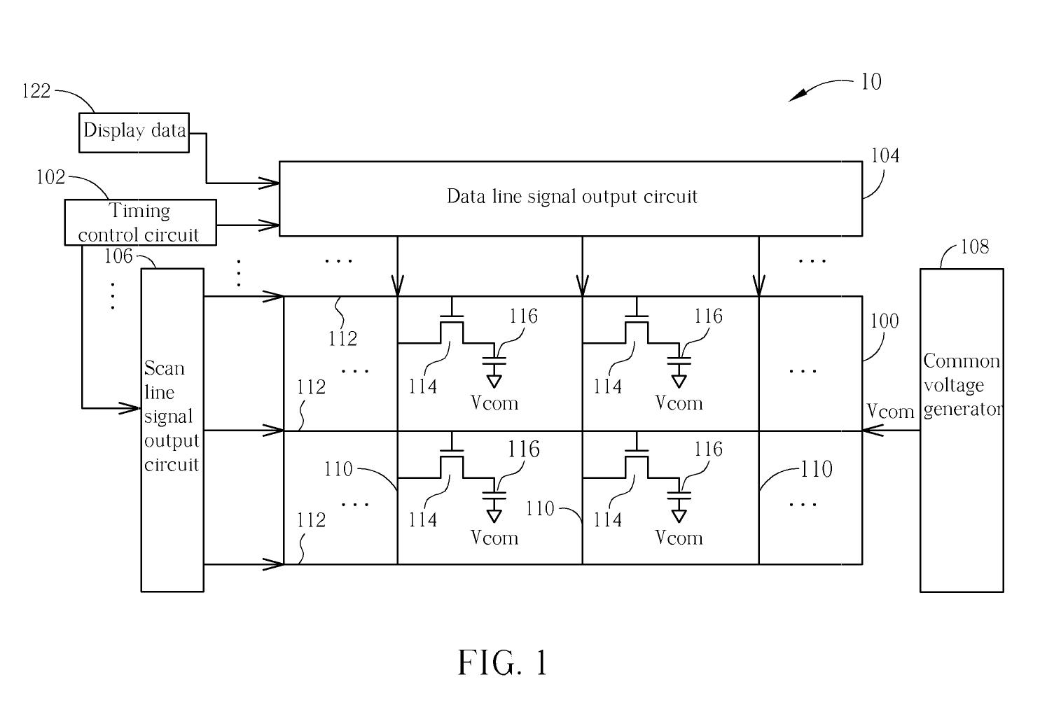

FIG. 2A to 2C illustrate schematic diagrams of output waveforms of a frame rate control driving method of the prior art.

FIG. 3 illustrates a schematic diagram of a driving process of a flat panel display according to an embodiment of the present invention.

FIG. 4A to 4C illustrate schematic diagrams of output waveforms of generating different gray levels according to the driving process given in FIG. 3.

FIG. 5 illustrates a schematic diagram of output waveforms of generating gray levels according to the driving process given in FIG. 3.

FIG. 6 is a schematic diagram of a driving device used in a flat panel display of an embodiment of the present invention.

### DETAILED DESCRIPTION

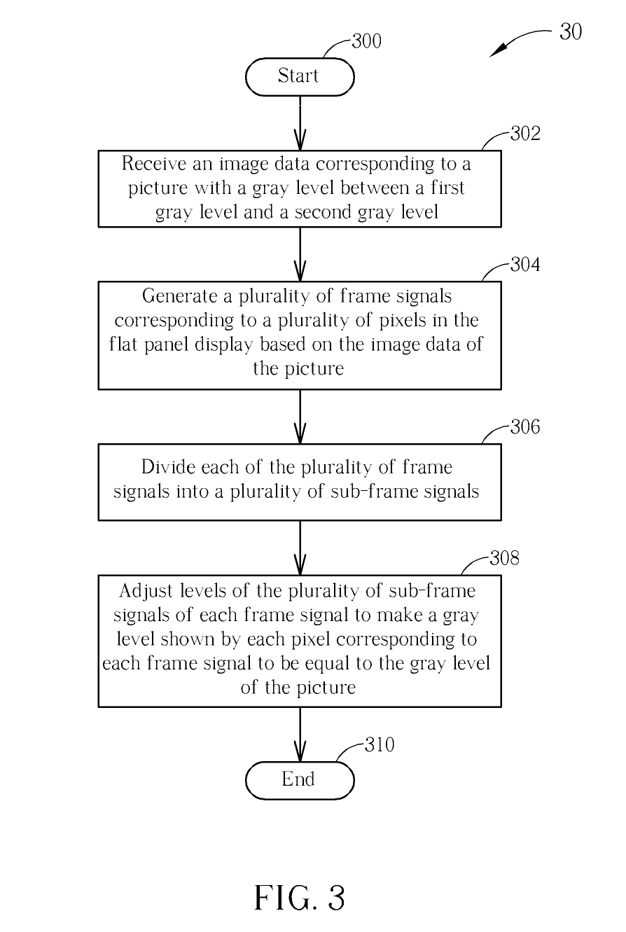

Please refer to FIG. 3. FIG. 3 illustrates a schematic diagram of a driving process 30 of a flat panel display according to an embodiment of the present invention. The driving process 30 comprises the following steps:

STEP 300: Start.

STEP 302: Receive an image data corresponding to a picture with a gray level between a first gray level and a second gray level.

STEP 304: Generate a plurality of frame signals corresponding to a plurality of pixels in the flat panel display based on the image data of the picture.

STEP 306: Divide each of the plurality of frame signals into a plurality of sub-frame signals.

STEP 308: Adjust levels of the plurality of sub-frame signals of each frame signal to make a gray level shown by each pixel corresponding to each frame signal to be equal to the gray level of the picture.

STEP 310: End.

According to the driving process 30, for a picture with a gray level between a first gray level and a second gray level, the present invention divides each frame signals of each pixel in the picture into a plurality of sub-frame signals, and adjusts levels of the sub-frame signals according to the first gray level and the second gray level, so as to make a gray level corresponding to each frame signal to be equal to the gray level of the picture. That is, for a channel, the present invention can output more than two gray levels within the same frame, to use interpolation to generate the gray levels between the first gray level and the second gray level. Under this circumstance, since more than two of the gray levels can be output within a frame, the flicker phenomena owing to under speed of frame rate can be avoided, and no extra chip area or cost for the driving circuit is required.

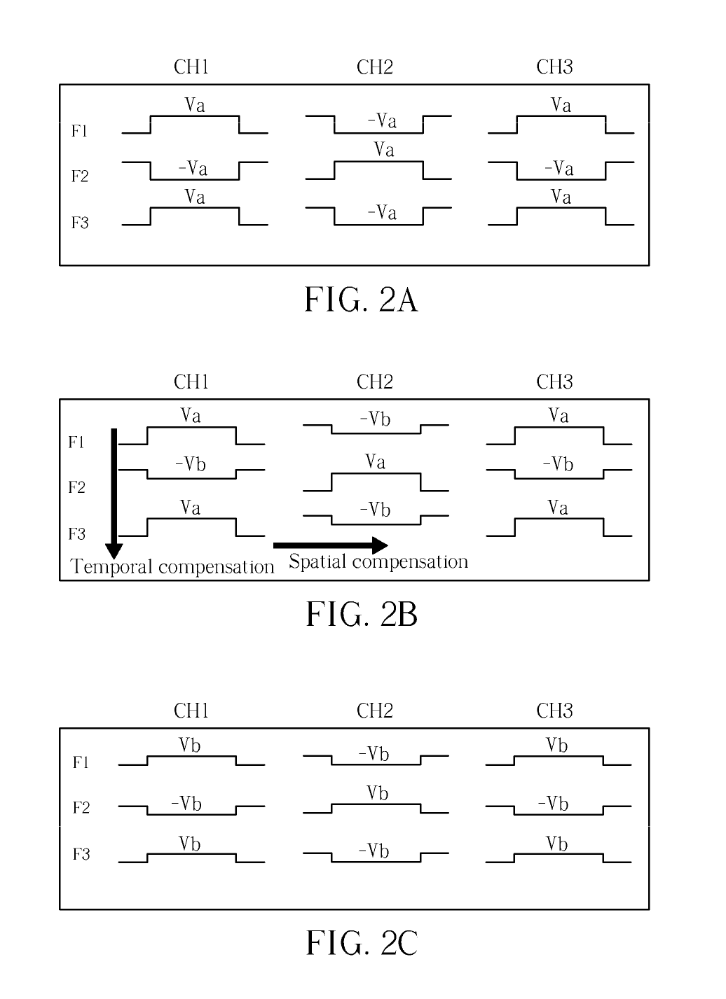

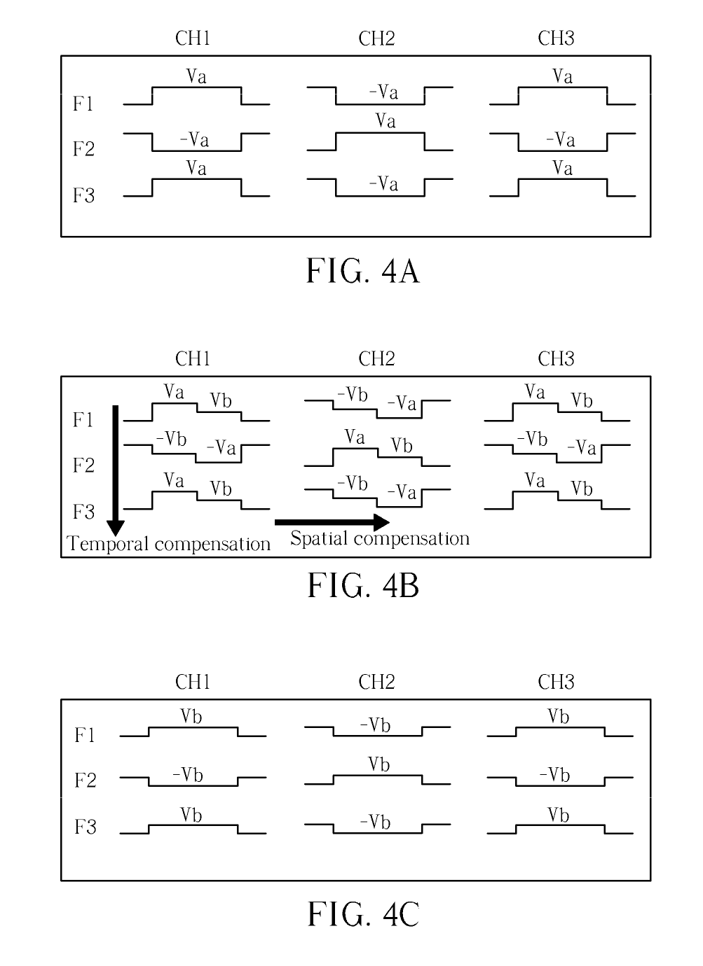

Therefore, the driving process 30 can output more than two gray levels in the same frame, and use interpolation to output gray levels between the first gray level and the second gray level. Therefore, even if the display speed is not fast enough, since the present invention can output more than two gray levels within a frame, the flicker phenomena can be reduced. For example, please refer to FIG. 4A to 4C. FIG. 4A to 4C illustrate schematic diagrams of output waveforms corresponding to frame signals of different channels and of different frames when an (N+1) gray level, a (2N+1)/2 gray level and an N gray level are generated according to the driving process 30. To clearly compare the difference between the present invention and the prior art, the related symbols shown in FIG. 2A to 2C and their definitions are continued to be used. In FIG. 4B, as to the channel CH1, the driving voltages of the frame F1 are composed of voltages Va and Vb. That is, in the frame F1, the present invention sequentially outputs the driving voltage Va corresponding to the (N+1) gray level and the driving voltage Vb corresponding to the N gray level. As to the channel CH1, in the frame F2, the present invention sequentially outputs the driving voltage (−Vb) corresponding to the N gray level and the driving voltage Va corresponding to the (N+1) gray level. The rest can be deduced by analogy. It can be known that, as to the (2N+1)/2 gray level, the present invention sequentially outputs the driving voltages corresponding to the (N+1) and N gray levels to get (2N+1)/2 gray level by interpolation. In other words, besides using the N and (N+1) gray levels to perform temporal and spatial compensations, the present invention also use interpolation to generate the (2N+1)/2 gray level within the same frame, such that the (2N+1)/2 gray level can be observed in the same frame period. By this way, more gray levels can be generated, and the picture flicker owing to under speed of frame rate can be avoided, as well as no extra cost is needed.

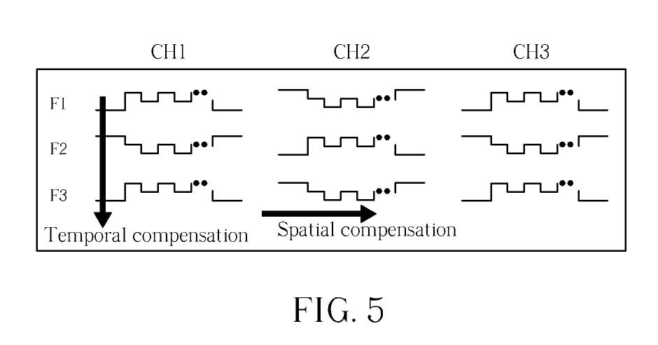

Note that, FIG. 4A to 4C simply illustrate the embodiment of the present invention, which outputs two gray levels within the same frame. Certainly, the present invention can output more than two gray levels within the same frame as shown in FIG. 5. Besides, in FIG. 4A to 4C, a proportion of each gray level within a frame can also be adjusted to get the required gray level. Or, as in FIG. 5, the required level can also be achieved by adjusting the number of sub-frame signal groups corresponding to different gray levels. For example, if the number of the sub-frame signals is (X+Y), where X denotes the number of sub-frame signals of a first sub-frame signal group corresponding to the (N+1) gray level, and Y denotes the number of sub-frame signals of a second sub-frame signal group corresponding to the N gray level. Under this condition, if X equals Y, it can be interpolated to get the (2N+1)/2 gray level. If X and Y are different, it can be interpolated to get a N+(X/(X+Y)) gray level.

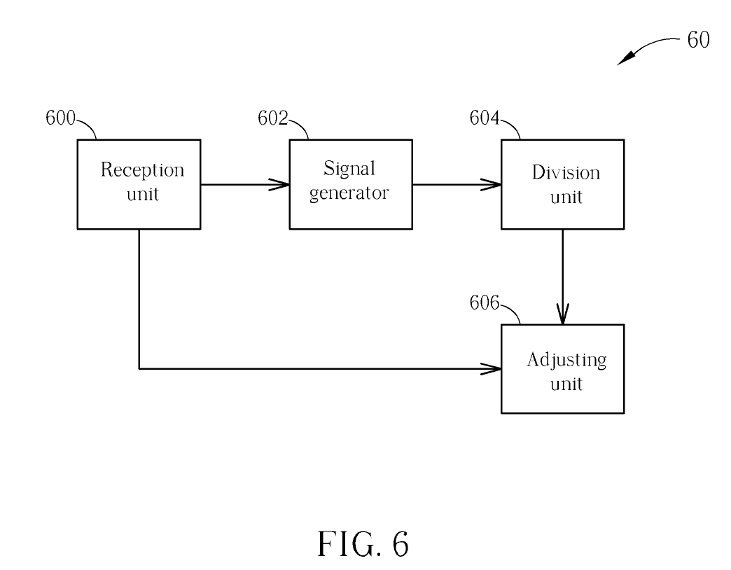

Briefly speaking, the driving process 30 is to output more than two gray levels within a frame and output gray levels between the first gray level and the second gray level via interpolation. As a result, even if the display speed is not fast enough, since the present invention can output more than two gray levels within a frame, the flicker phenomena can be reduced. As to implementation of the driving process 30, please refer to FIG. 6. FIG. 6 is a schematic diagram of a driving device 60 used in a flat panel display according to an embodiment of the present invention. The driving device 60 comprises a reception unit 600, a signal generator 602, a division unit 604 and an adjusting unit 606. The reception unit 600 is used for receiving image data corresponding to a picture with a gray level between a first gray level and a second gray level. The signal generator 602 is coupled to the reception unit 600, and used for generating the plurality of frame signals corresponding to the plurality of pixels in the flat panel display based on the image data of the picture. The division unit 604 is coupled to the signal generator 602, and used for dividing each of the plurality of frame signals into the plurality of sub-frame signals. The adjustment unit 606 is coupled to the division unit 604 and the reception unit 600, and used for adjusting levels of the plurality of sub-frame signals of each frame signal based on the first gray level and the second gray level to make the gray level shown by each pixel corresponding to each frame signal to be equal to the gray level of the picture. The driving device 60 is used for realizing the driving process 30, and the detailed operation can be referred to the above description, and is not to be repeated hereafter.

To sum up, as to the same channel, the present invention outputs more than two gray levels in a frame, so as to output the gray levels between the first gray level and the second gray level by interpolation. As a result, since more than two gray levels can be produced in a frame, picture flicker owing to under speed of frame can be avoided, and no extra cost is needed.

Those skilled in the art will readily observe that numerous modifications and alterations of the device and method may be made while retaining the teachings of the invention.

What is claimed is:

1. A method for driving a flat panel display comprising:
receiving image data corresponding to a picture with a gray level between a first gray level and a second gray level;
generating a plurality of frame signals corresponding to a plurality of pixels in the flat panel display based on the image data of the picture;
dividing each of the plurality of frame signals into a plurality of sub-frame signals; and
adjusting levels of the plurality of sub-frame signals of each frame signal based on the first gray level and the second gray level to make a gray level shown by each pixel corresponding to each frame signal to be equal to the gray level of the picture.

2. The method of claim 1, wherein dividing each of the plurality of frame signals into the plurality of sub-frame signals further comprises dividing the plurality of sub-frame signals of the plurality of frame signals into a first sub-frame signal group and a second sub-frame signal group.

3. The method of claim 2, wherein adjusting the levels of the plurality of sub-frame signals of each frame signal based on the first gray level and the second gray level to make the gray level shown by each pixel corresponding to each frame signal to be equal to the gray level of the picture, comprises adjusting levels of sub-frame signals of the first sub-frame signal group to a level corresponding to the first gray level, and adjusting levels of sub-frame signals of the second sub-frame signal group to a level corresponding to the second gray level, so as to make the gray level shown by each pixel corresponding to each frame signal to be equal to the gray level of the picture.

4. The method of claim 2, wherein a number of sub-frame signals in the first sub-frame signal group is equal to a number of sub-frame signals in the second sub-frame signal group.

5. The method of claim 2, wherein a number of sub-frame signals in the first sub-frame signal group is different from a number of sub-frame signals in the second sub-frame signal group.

6. A driving device used in a flat panel display comprising:
a reception unit for receiving image data corresponding to a picture with a gray level between a first gray level and a second gray level;
a signal generator coupled to the reception unit, for generating the plurality of frame signals corresponding to the plurality of pixels in the flat panel display based on the image data of the picture;
a division unit coupled to the signal generator, for dividing each of the plurality of frame signals into the plurality of sub-frame signals; and
an adjustment unit coupled to the division unit and the reception unit, for adjusting levels of the plurality of sub-frame signals of each frame signal based on the first gray level and the second gray level to make the gray level shown by each pixel corresponding to each frame signal to be equal to the gray level of the picture.

7. The device of claim 6, wherein the division unit is further used for dividing the plurality of sub-frame signals of the plurality of frame signals into a first sub-frame signal group and a second sub-frame signal group.

8. The device of claim 7, wherein the adjustment unit is further used for adjusting levels of sub-frame signals of the first sub-frame signal group to a level corresponding to the first gray level, and adjusting levels of sub-frame signals of the second sub-frame signal group to a level corresponding to the second gray level, so as to make the gray levels shown by each pixel corresponding to each frame signal to be equal to the gray levels of the picture.

9. The device of claim 7, wherein a number of sub-frame signals in the first sub-frame signal group is equal to a number of sub-frame signals in the second sub-frame signal group.

10. The device of claim 7, wherein a number of sub-frame signals in the first sub-frame signal group is different from a number of sub-frame signals in the second sub-frame signal group.
